(19) United States
(12) Patent Application Publication
(10) Pub. No.: US 2004/0159038 A1
(43) Pub. Date: Aug. 19, 2004

(54) Wild game conditioning system and method

(76) Inventor: Robert Hageman, Austin, TX (US)

Correspondence Address: DAVID G. HENRY, 7th Floor, 900 Washington Avenue, P.O. Box 1470, Waco, TX, 77603-1470, US

(21) Appl. No.: 10/369,448

(22) Filed: Feb. 18, 2003

(51) Int. Cl. A01K 73/00

(52) U.S. Cl. 43/10

(57) ABSTRACT

A wild game desensitization system and associated method for desensitizing wild game to the perceptible evidence of presence present at a hunting site. The system includes scent dissemination, sound generating, and movement generating systems, all associated with a mannequin for conditioning game to human presence, and thereby reducing the deterrent effect of actual human presence after the system has been at such hunting site for an extended period of time.

### BACKGROUND OF THE INVENTION

1. Field of the Invention

The present invention relates to systems and methods for hunting wild game, particularly deer.

2. Background Information

Historically, methods for increasing the likelihood of successfully hunting wild game (deer in particular) have involved masking the presence of humans. This arises from the fact that deer are ordinarily quite easily frightened away, not only by the site of humans, but by noises made by them, and even scents and smells produced by hunters when detected by the deer.

Camouflage, deer blinds, reducing noise to an absolute minimum, and the use of scent substances in an attempt to prevent detection by game have all been utilized by hunters so that their prey will more likely approach the hunters' position.

The above measures for masking the presence of humans can go just so far. Humans simply cannot become completely invisible, scentless, or noiseless. At some point of proximity, game will detect human hunters, despite the best of masking efforts.

A shortsightedness of most in the hunting arena is reflected by their sole focus on masking human presence, rather than somehow (instead of, or in addition to masking) reducing the impact on game, once that presence is detected. In other words, little has been done to effectively condition game to human presence, and thereby reduce the disruptive impact on hunting of a game animal's perception (visually, audibly, or through scent detection) of human presence.

One inventor—Berry (U.S. Pat. No. 6,079,139)— has proposed a very simple moving mannequin which is designed to condition deer to the movement associated with human presence. However, Berry did not go far enough, and no one appears to have grasped the multiple ways in which a game animal might be truly effectively and beneficially conditioned to human presence.

In view of the foregoing, it would well serve those involved in game hunting to provide a method and associated system through the use of which game animals can truly be conditioned to the presence of human hunters, such that the slightest detection of the presence of the latter will not send the animals running.

### SUMMARY OF THE INVENTION

It is an object of the present invention to provide a method and associated apparatus for facilitating successful wild game hunting.

It is another object of the present invention to provide a method and associated apparatus for facilitating successful wild game hunting by reducing the reactionary impact on wild game animals to the detection of nearby humans.

It is another object of the present invention to provide an improved method and associated apparatus for conditioning game animals to the presence of humans.

In satisfaction of these and related objects, the present invention provides a method and associated example apparatus for conditioning game animals to the presence of humans with respect to sights, sounds and smells. An apparatus of the present invention includes means for generating visually perceptible movement, noises which mimic human activity, and releasing scents normally associated with human hunters. The associated method involves placing the apparatus at an intended, future hunting site, and leave

### BRIEF DESCRIPTION OF THE DRAWINGS

FIG. 1 is a perspective view of the preferred embodiment.

FIG. 2 is a of the preferred embodiment.

FIG. 3 is of the preferred embodiment.

FIG. 4 is of the preferred embodiment.

FIG. 5 is of the preferred embodiment.

FIG. 6 is of the preferred embodiment.

### DETAILED DESCRIPTION OF THE PREFERRED EMBODIMENT

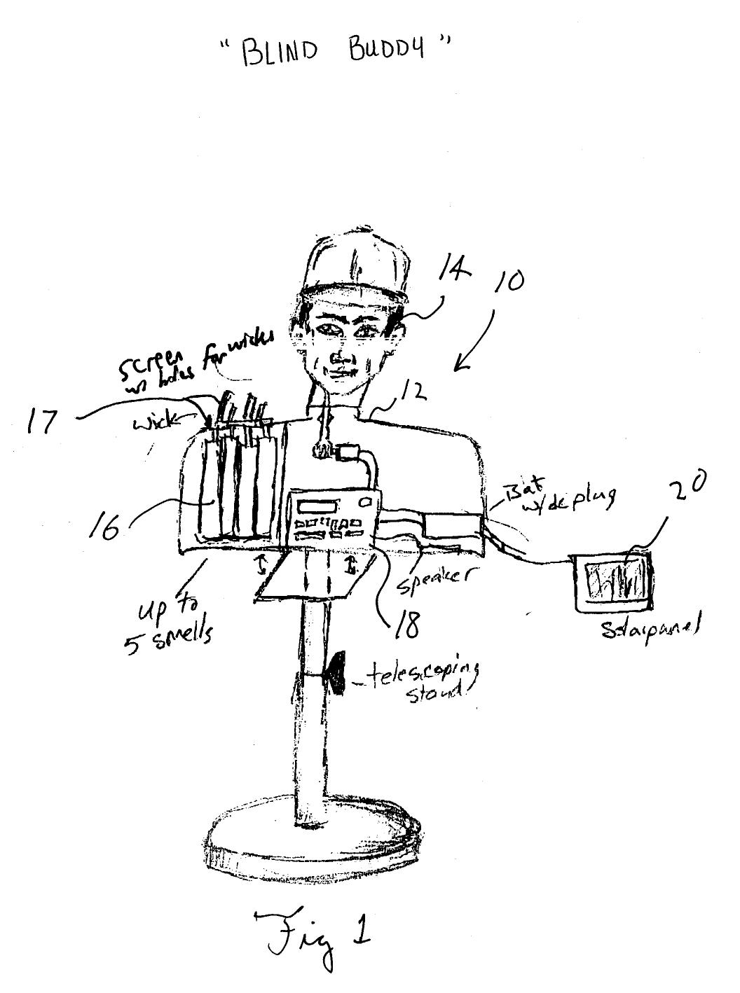

Referring to FIG. 1, the game conditioning system 10 of the present invention, in its preferred embodiment, includes an at least partial mannequin 12 which is configured to resemble a hunter. This may range from a human-appearing head 14 mounted on a supporting framework, a head 14 with a partial body portion (shown in FIG. 1), or even a full-body mannequin (not shown).

At least the head portion 14 of mannequin 12 is mechanically linked with a mechanical device (not shown in the drawings) which, under power of an electric motor, and which suitable mechanical linkages, causes head 14 to move in manners dictated by the mechanical linkages just mentioned. A detailed disclosure of the mechanical linkages need not be provided herein, as the design and configuration of such are well within the skills and knowledge of any person involved in moving mannequin or other relatively simple mechanical fields. The key element here is simply that at least the head 14 move, and through such movement, desensitize nearby game to observing such movement.

Another feature of the present system 10 relates to desensitization of game to scents associated with human presence. Receptacles 16 containing liquid scents are included in the present system 10. The preferred embodiment includes receptacles 16 which, in turn, include wicks 17 for wicking a liquid scent composition for evaporation and dissemination. Embodiments of the present invention will include one or more scents, such as human sweat, coffee, tobacco smoke, burning wood (such as associated with a camp fire) and other food scents. The preferred embodiment will include most, if not all of these. Custom chemical formulators will be able to provide the required scent fluids for use in system 10, with the appropriate aromatic base to insure evaporative dissemination. This feature of the present system serves to desensitize nearby game to the smells associated with human presence.

Another feature of the present invention relates to the sounds associated with human presence in the field. The preferred embodiment of the present invention includes some form of electronic sound generator 18. As anyone involved in hunting wild game knows, the slightest noise can send game animals running. Therefore, including a sound generator 18 for producing synthesized sounds of human talking, clanging of pots and pans, crackling of twigs and grass, etc. will serve to desensitize game to the aural aspects of human presence. Sound generators for producing voices, and any number of other sounds are readily obtainable in a wide variety of quality of sound ranges. Therefore, specific specifications are not here required for an enabling disclosure.

In order for system 10 to achieve its intended purpose, sound and movement must occur regularly, over an extended period of time. Thus, one would place system 10 in a deer blind, for example, and leave it there for quite some time (even weeks or months). The mechanical movement mechanism and the sound generator 18 should activate regularly (hourly would be preferable). The sound generator 18 and mechanical movement system will obviously require electrical power of some kind. Batteries may be suitable, particularly for the sound generator, for a rather extended period of time, as these devices tend to be rather low-power drain devices. However, the mechanical movement system will require such a level of power that batteries are likely to run down after a fairly short period of time, if the systems are activated on a regular basis (as they must, if the desensitization is to be effective). Therefore, the preferred embodiment of the present invention includes a solar cell 20 suitable for charging the battery (or battery pack) which powers these components.

Activating the movement mechanism and the sound generator can be by way of timing/control mechanisms separately associated with each component, or may be by a central control module which actives each on a pre-programs (or even variably programed) basis. Such control modules are readily available, even in the hunting related fields, such as automatically timed deer feeding devices, and they, or analogous designs, can readily be adapted for use in the present system 10.

One additional feature which may optionally be included in system 10 relates to lights. As with any visual stimulus which might frighten away wild game, artificial light can be something with which one might want game to become familiar and thereby desensitized. Therefore, some form of light emitting device(s) (not shown in the drawings) may be included in system 10 for this purpose. Some form of flashing light is believed to be optimal for this purpose, because it would tend to draw the most attention.

The above description of system 10 is intended to be of the preferred, “all bells and whistles” version of the present invention. It should be noted that the use of human and human activity-related scents to desensitize game, rather than the conventional use of means to camouflage those scents, is a revolutionary approach to aiding the hunter with respect to frightening away wild game. The same is true with respect to generating, rather than suppressing human activity-related sounds. Therefore, while the preferred embodiment includes each of the described features, a sub-set of these features will, nevertheless, fall within the intended scope of the present invention and the claims which directly, or through proper application of the doctrine of equivalents, encompass such invention. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An game desensitization system comprising:
a mannequin member; and
scent emitting means for disseminating human activity-related scents positioned in proximity to said mannequin member.

2. The system of claim 1 wherein said human activity-related scents include a composition which is perceptible as human scent.

3. The system of claim 1 further comprising mechanical movement means attached to said mannequin member for imparting motion to said mannequin member upon actuation of said mechanical movement means.

4. The system of claim 2 further comprising mechanical movement means attached to said mannequin member for imparting motion to said mannequin member upon actuation of said mechanical movement means.

5. The system of claim 1 further comprising sound generator means for, upon actuation of said sound generator means, producing synthesized sounds.

6. The system of claim 3 further comprising sound generator means for, upon actuation of said sound generator means, producing synthesized sounds.

7. The invention of claim 5 wherein said synthesized sounds include sounds comprising representations of human speech.

8. The invention of claim 3 further comprising a control means interfaced with said mechanical movement means for periodically actuating said mechanical movement means and thereby effecting movement of said mannequin.

9. The invention of claim 6 further comprising:
mechanical movement means control means interfaced with said mechanical movement means for periodically actuating said mechanical movement means and thereby effecting movement of said mannequin; and
sound generator control means interfaced with sound generator means for periodically actuating said sound generator means and thereby effecting generation of said synthesized sounds.

10. A method for desensitizing wild game to human presence and activity comprising:
selecting a game desensitization system comprising:
a mannequin member; and
scent emitting means for disseminating human activity-related scents positioned in proximity to said mannequin member;
placing said system at a hunting facility or location for a time prior to hunting activity at such hunting facility or location.

11. The method of claim 10 wherein said human activity-related scents include a composition which is perceptible as human scent.

12. The system of claim 10 wherein said system further comprises mechanical movement means attached to said mannequin member for imparting motion to said mannequin member upon actuation of said mechanical movement means.

13. The system of claim 11 wherein said system further comprises mechanical movement means attached to said mannequin member for imparting motion to said mannequin member upon actuation of said mechanical movement means.

14. The method of claim 10 wherein said system further comprises sound generator means for, upon actuation of said sound generator means, producing synthesized sounds.

15. The method of claim 12 wherein said system further comprises sound generator means for, upon actuation of said sound generator means, producing synthesized sounds.

16. The invention of claim 14 wherein said synthesized sounds include sounds comprising representations of human speech.

17. The method of claim 12 wherein said system further comprises control means interfaced with said mechanical movement means for periodically actuating said mechanical movement means and thereby effecting movement of said mannequin.

18. The method of claim 15 wherein said system further comprises:
mechanical movement means control means interfaced with said mechanical movement means for periodically actuating said mechanical movement means and thereby effecting movement of said mannequin; and
sound generator control means interfaced with sound generator means for periodically actuating said sound generator means and thereby effecting generation of said synthesized sounds.
